(19) United States
(12) Patent Application Publication
(10) Pub. No.: US 2019/0381936 A1
(43) Pub. Date: Dec. 19, 2019

(54) DEVICE FOR ASSISTING NIGHT-TIME ROAD NAVIGATION

(71) Applicant: PSA AUTOMOBILES SA, Poissy (FR)

(72) Inventors: Loic BAYARD, LES ULIS (FR); Benjamin MENNESSON, CHEVREUSE (FR)

(21) Appl. No.: 16/477,459

(22) PCT Filed: Feb. 2, 2018
(86) PCT No.: PCT/FR2018/050261

§ 371 Date: Jul. 11, 2019

(30) Foreign Application Priority Data
Feb. 7, 2017 (FR) 1751019

(51) Int. Cl. B60R 1/00; B60K 35/00; G06K 9/00; G01C 21/36

(52) U.S. Cl. CPC B60R 1/00; B60K 35/00; G06K 9/00791; B60K 2370/166; B60R 2300/8053; B60R 2300/106; B60K 2370/176; G01C 21/3647

(57) ABSTRACT

The invention relates to a device for assisting night-time driving of a vehicle, comprising at least one display and a night vision system capable of capturing images under conditions of darkness and transmitting them to said display, said display being capable of displaying a graphics page (31) comprising a first area (31.1) and second area (31.2) arranged next to said first area (31.1), the display (23) having a first display mode in which said first area (31.1) comprises operating information of the vehicle, characterised in that the display is capable, in response to receiving an alarm signal coming from a night vision system, of displaying, in the second area (31.2), images coming from the night vision system.

### CROSS-REFERENCE TO RELATED APPLICATIONS

This application is the US National Stage under 35 USC § 371 of International Application No. PCT/FR2018/050261, filed 2 Feb. 2018 which claims priority to French Application No. 1751019 filed 7 Feb. 2017, both of which are incorporated herein by reference.

### BACKGROUND

The invention relates to a device for assisting navigation and more particularly assisting night-time road navigation for a vehicle, in particular a motor vehicle.

“Night-vision” systems are known, which use a camera more sensitive than the human eye to film a scene in front of the vehicle and which render this image on a screen for the driver. The aim of these systems is to be able to drive at night or in conditions of reduced visibility (i.e., in rain, snow, fog, etc.) with a higher visibility than that offered by headlights, while avoiding glare. These systems give the driver access to information of the road scene that he does not perceive or does not perceive very well by looking at the road but that he has the possibility of seeing if he looks at the screen, such as the presence of a pedestrian on the side of the road or even a road profile in the distance.

One of the drawbacks of a system of this type is that once it is active it displays images constantly. These images may be found to be distracting or annoying for the driver. The only way to stop this display is to deactivate the system. However, in this case the driver no longer benefits from the alerts of the system.

For example, French patent application FR2902381 discloses a night-vision system that implements: detection of the location of the area of the road scene by an image-taking device, implementation of a synthesis image corresponding to the area of the located road scene, and merging of the image captured by the image-taking device and the synthesis image, the result of the merging being displayed on the screen of the vehicle.

### SUMMARY

The object is therefore to propose a night-vision device that makes it possible on the one hand not to distract a driver and on the other hand to alert the driver in a precise and effective manner when a threat is detected.

More precisely, for this purpose a device is proposed for assisting night-time driving of a vehicle, comprising at least one display and a night vision system capable of capturing images under conditions of darkness and transmitting them to the display, the display being capable of displaying a graphics page comprising a first display area and second display area arranged next to the first display area, the display having a first display mode in which the first display area comprises operating information of the vehicle, wherein the display is capable, in response to receiving an alarm signal coming from a night vision system, of displaying, in the second display area, images coming from the night vision system.

This makes it possible, when an alert is emitted by the night-vision system, to punctually display images coming from the system. Thus, when no alert is being emitted, these images do not disturb the driver. These images are displayed in a predetermined area (the second display area) in such a way that the vehicle operating information (displayed in the first display area) remains visible. Continuing to display this information makes it possible not to distract the driver unnecessarily, while he maintains visual reference to these displays.

Finally, displaying the images makes it possible for the driver to visualize very precisely the nature of the alert being signaled by the night-vision system.

Advantageously, the night-vision system is capable of outputting a first and a second level of alert, the first level of alert indicating a higher risk than the second level of alert, the display is configured to display images coming from the night-vision system in the second area, in the first display mode, only in response to receiving an alert signal corresponding to a first level of alert.

In this way, the driver is not disturbed by lower-importance alerts. The images coming from the night-vision system are only displayed when a first-level alert is outputted.

Advantageously, the display is configured to display the images coming from the night-vision system in the first display mode, in an ad hoc manner, only as long as the alert signal continues to be received.

In this way, the driver is not disturbed by the images coming from the night-vision system when the threat associated with the alert has disappeared.

Advantageously, the display comprises means for resizing and/or cropping the images coming from the night-vision system, the image displayed in the second area in the first display mode being cropped or resized.

This feature makes it possible to display an image coming from the night-vision system in a reduced area while maintaining a high information level focused on the threat associated with the alert.

Advantageously, the display has a second display mode in which the display constantly displays images coming from the night-vision system in the first area.

The second display mode makes it possible for the driver to have access to images coming from the vision system when he wishes.

Advantageously, the display is capable of switching from the first display mode to the second display mode and vice versa in response to receiving a command from a user.

Advantageously, the display is capable of displaying, in the first display mode, an indicator indicating whether the night-vision system is active.

The indicator makes it possible to signal to the driver whether the night-vision system is activated, since in the absence of a constantly displayed image the driver has no other way of knowing whether the system is active when no alert is underway.

Advantageously, in the first display mode, the first area comprises operating data of the vehicle or guide data.

Advantageously, the first area is displayed in a central part of the display.

Advantageously, the graphics page further comprises a third display area, the second and third display areas being located on either side of the first display area.

The invention further relates to a vehicle comprising a device for assisting night-time driving as described above.

### BRIEF DESCRIPTION FO THE FIGURES

Further features and advantages of the invention will be apparent from examining the followed detailed description and the accompanying drawings, in which:

FIG. 1 shows a motor vehicle dashboard;

FIG. 2 is a block diagram of the system;

FIG. 3a shows a first display mode;

FIG. 3b shows the first display mode when an alert of the night-vision system is being outputted;

FIG. 4 shows a second display mode.

### DETAILED DESCRIPTION

The accompanying drawings may not only supplement the invention, but also contribute to defining it where necessary.

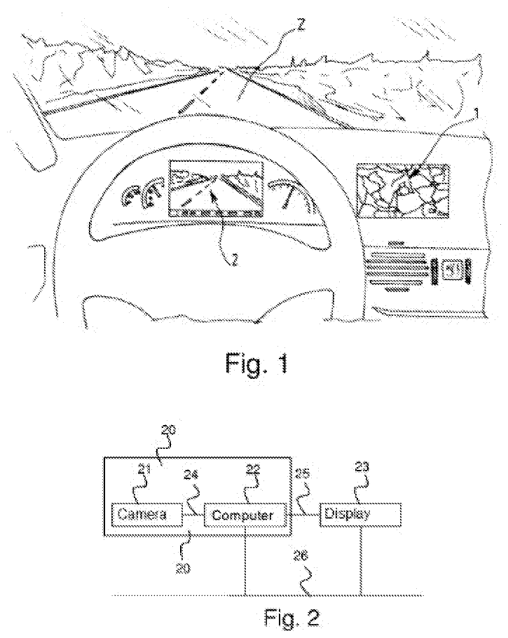

The drawing of FIG. 1 shows a motor vehicle dashboard equipped with two screens and a night-time road navigation system. A first screen 1 is a screen of a conventional GPS (“global positioning system”) road navigation system, displaying, in a manner known per se, a map and routes, perspectives, colors and information. A second screen 2 is a screen of a night-vision system. On the screen 2, the result is similar to a high-detail black-and-white video image of the road scene denoted as Z.

The architecture of the night-vision system according to the invention is illustrated by the block diagram of FIG. 2.

The system 20 comprises an image-capture device 21 and a computer 22 that communicates with at least one display 23.

The image-capture device 21 is formed by at least one night-vision camera, installed at the front of the vehicle.

In a first technology, the camera, discreetly integrated into the front of the vehicle, receives the images of infrared projectors, reflected by the road. In a second technology, a camera captures the thermal radiation of the elements of the scene.

These images are transmitted to the computer 22, to undergo processing, via a first video link 24, for example of the LVDS type. As is known, an LVDS (“low-voltage differential signaling”) link makes it possible to connect two pieces of equipment and to transfer both video data and non-video data.

The computer 22 comprises a module (electronic module) for processing images coming from the capture device 21.

The processed images are transmitted to the display 23 via a second video link 25, for example of the LVDS type.

In a known manner, the computer 22 comprises a pedestrian detection module. The detection module further outputs an alert signal to the display 23 on a CAN bus 26 of the vehicle and/or on the second video link 25, for example of the LVDS type, when a cyclist or an animal is detected.

The computer 22 is capable of outputting a first and a second level of alert, the first level of alert indicating a higher risk than the second level of alert. The first level of alert corresponds, for example, to a pedestrian or an animal being detected on the road. The second level of alert corresponds, for example, to a pedestrian or an animal being detected on the roadside.

Advantageously, pedestrians or animals detected on the road or on the roadside can thus be highlighted, for example by making them flash in a color (for example red or yellow) and/or by displaying a pictogram.

The display 23 may be the second screen 2 in the drawing of FIG. 1 or another image projection system in accordance with another embodiment. Thus, the display 23 may be a conventional LCD (“liquid crystal display”) screen, for example, or else a HUD (“head-up display”) image projection system, for example.

The display 23 has at least two different display modes. Each of the two display modes has a first display area 31.1 located in the central part of the screen. A second display area 31.2 and a third display area 31.3 are arranged on either side of the first display area 31.1, to the right and to the left, respectively. The display 23 has for example at least one of the modes described hereinafter.

FIG. 3a shows a first display mode 31 where the first display area 31.1 comprises operating data of the vehicle. In the example, this is an indication of the speed of the vehicle, for which the value is 90 km/h.

The second display area 31.2 has guidance instruction.

The third display area 31.2 also comprises an indication of the speed of the vehicle, but in the form of a speedometer.

The display area 31.1 is for displaying information constantly.

The second 31.2 and third 31.3 areas are capable of displaying one-time pieces of information (for example navigation instructions or alerts).

FIG. 3b shows the first display mode 31 when the display 23 is receiving an alert coming from the night-vision system.

The first and third display areas are identical to FIG. 3a. By contrast, the second area is displaying an image originating from the camera 21 as well as a pictogram.

A second display mode 31 is shown in FIG. 4, where the first display area 31.1 comprises an image from the camera 21 and where the second display area 31.2 and a third display area 31.3 comprise operating data of the vehicle. In the example, the second display area 31.2 comprises an indication of a level, for which the value is approximately 3.5.

The third display area 31.3 comprises an indication of the speed of the vehicle, for which the value is 90 km/h.

In the first display area 31.1, the image originating from the camera 21 comprises an indication (in the form of a colored polygon) that an animal is being detected.

1. A device for assisting night-time driving of a vehicle, the device comprising at least one display and a night vision system capable of capturing images under conditions of darkness and transmitting said images to said display, said display being capable of displaying a graphics page comprising a first display area and second display area arranged next to said first display area, the display having a first display mode in which said first display area displays operating information of the vehicle, wherein the display is capable, in response to receiving an alarm signal coming from said night vision system, of displaying, in the second display area, images captured by the night vision system.

2. The device for assisting night-time driving according to claim 1, wherein the night-vision system is capable of emitting an alert signal indictive of a first level of alert and a second level of alert, the first level of alert indicating a higher risk than the second level of alert, said display being configured to display images coming from the night-vision system in the second display area, in the first display mode, only in response to receiving an alert signal corresponding to a first level of alert.

3. The device for assisting night-time driving according to claim 1, wherein said display is configured to display the images coming from the night-vision system in the first display mode only as long as said alert signal continues to be received.

4. The device for assisting night-time driving according to claim 1, wherein the display comprises means for resizing and/or cropping the images coming from the night-vision system, the image displayed in the second display area in the first display mode being cropped or resized.

5. The device for assisting night-time driving according to claim 1, wherein the display has a second display mode in which the display constantly displays images coming from the night-vision system in said first display area.

6. The device for assisting night-time driving according to claim 5, wherein the display is capable of switching from the first display mode to the second display mode and vice versa in response to receiving a command from a user.

7. The device for assisting night-time driving according to claim 1 wherein the first display area is displayed in a central part of the display.

8. The device for assisting night-time driving according to claim 7, wherein the graphics page further comprises a third display area, the second and third display areas being located on either side of the first display area.

9. A vehicle comprising a device for assisting night-time driving according to claim 1.
